(19) United States
(12) Patent Application Publication
(10) Pub. No.: US 2026/0357839 A1
(43) Pub. Date: Nov. 12, 2026

(54) STACKED BODY

(71) Applicant: FIVEGRAND INTERNATIONAL CO., LTD., New Taipei City (TW)

(72) Inventor: TING-JUI WANG, New Taipei City (TW)

(73) Assignee: FIVEGRAND INTERNATIONAL CO., LTD., New Taipei City (TW)

(21) Appl. No.: 19/561,557

(22) Filed: Mar. 10, 2026

(30) Foreign Application Priority Data
May 8, 2025 (TW) 114117348

(51) Int. Cl. F16B 21/09; F16B 5/00

(52) U.S. Cl. CPC F16B 21/09; F16B 5/00

(57) ABSTRACT

A stacked body includes a head portion and a neck portion, the stacked body is configured to be disposed on a base body, and the head portion passes through an entering portion of an object and enters a limiting portion of the object through the neck portion, to cause the stacked body to limit at least one object. In this way, combination and separation of at least two objects may be completed, thereby achieving an effect of repeated and rapid combination and separation.

### CROSS-REFERENCE TO RELATED APPLICATION

This non-provisional application claims priority under 35 U.S.C. § 119(a) on Patent Application No(s). 114117348 filed in Taiwan, R.O.C. on May 8, 2025, the entire contents of which are hereby incorporated by reference.

### BACKGROUND OF THE INVENTION

### 1. Field of the Invention

The present disclosure provides a stacked body, and in particular, to a stacked body capable of implementing combination and separation of at least two objects, to implement repeated and rapid combination and separation.

### 2. Description of the Related Art

When at least two objects are combined, locking is usually performed by using a screw, to combine the objects.

However, for the foregoing conventional fixing manner, although the at least two objects or at least two objects may be fixed and combined in a manner in which the at least two objects are not easily separated, in addition to causing a case in which the at least two objects are not easily assembled, at least one object is not easily disassembled due to a fixing and combining manner of the screw.

Therefore, how to disclose a stacked body to implement combination and separation of the at least two objects and to have an objective of repeated and rapid combination and separation is a positive disclosure of the present disclosure.

### BRIEF SUMMARY OF THE INVENTION

In view of the shortage of the conventional technology, the inventor feels that the conventional technology is not perfect, and intends to research to overcome the shortage, to develop a stacked body, to implement combination and separation of at least two objects, thereby achieving an objective of repeated and rapid combination and separation.

To achieve the foregoing objective and other objectives, the present disclosure provides a stacked body, including at least one stacked body provided with at least one head portion and at least one neck portion, the stacked body is configured to be disposed on a base body, and the head portion passes through an entering portion of at least one object and enters a limiting portion of the object through the neck portion, to cause the stacked body to limit the object.

The present disclosure provides another method for assembling a stacked body. The method provides at least one stacked body provided with at least one head portion and at least one neck portion, to cause the stacked body to be disposed on a base body, and the head portion passes through an entering portion of at least one object and enters a limiting portion of the object through the neck portion, to cause the stacked body to limit the object.

In the stacked body, there are one, two, three, or more than three stacked bodies disposed on the base body.

In the stacked body, there are one, two, three, or more than three head portions.

In the stacked body, there are one, two, three, or more than three neck portions.

In the stacked body, there are one, two, three, or more than three objects.

In the stacked body, the base body is provided with a plurality of stacked bodies and a plurality of objects for limiting.

In the stacked body, the base body or the object is provided with a fastening body or a fixing portion, and the fastening body or the fixing portion performs transverse limiting after performing longitudinal limiting on the head portion of the stacked body and the limiting portion of the object.

In the stacked body, the fastening body or the fixing portion is a cylindrical body, an elastic fastening body, an internal thread body, an external thread body, an inner fastening body, an outer fastening body, a hole body, or a slot body.

In the stacked body, the head portion is larger than the limiting portion, the entering portion is larger than the head portion, and the neck portion is smaller than the limiting portion.

In the stacked body, the base body or the object is a circuit board, a heat sink, a chip, a slide track, a casing, a conductive body, a light guide body, an optical fiber, a tube, a chassis, a metal body, or a non-metal body, or the base body or the object has a carrier or a plurality of carriers, or the carrier or the plurality of carriers are an IC, a chip, a connector, a capacitor, a resistor, a heat sink, a fan, a printed circuit board, a conductive body, a light guide body, an optical fiber, a tube, a metal body, a non-metal body, or a plastic body.

In the stacked body, the base body or the object has a carrier or a plurality of carriers, or at least one carrier exists on the base body or the object, or on a top surface or a bottom surface of a plurality of layers of objects, or between objects, or an electric connection exists between carriers, or an electric connection exists between the base body, the object, the plurality of layers of objects, or the carrier, or the base body, the object, the carrier, or the plurality of carriers are a transistor, an IC, a semiconductor, a capacitor, a resistor, a heat sink, an electric wire, a connector, a circuit, a printed circuit board, a memory, a metal body, or a plastic body.

In the stacked body, the base body and the stacked body stacks two, three, or more layers of objects, and restrict longitudinal limiting of the objects.

In the stacked body, the base body and the stacked body stack two layers, three layers, or more than three layers of objects, restrict longitudinal limiting of the objects, and restrict transverse limiting of the objects by using a fastening body or a fixing portion.

In the stacked body, the stacked body is provided with a body portion, the body portion movably combines the head portion and the neck portion, the head portion is provided with an external thread portion, and the body portion is provided with an internal thread portion, configured to perform locking after the head portion enters the limiting portion to clip and fix the object.

In the stacked body, an elastic element is further included, the elastic element separately abuts against the body portion and the neck portion, to elastically abut against the limiting portion when the head portion enters the limiting portion, or to elastically abut against the limiting portion when the head portion enters the limiting portion, and the external thread portion of the head portion is locked into the internal thread portion of the body portion to clip and fix the object.

In the stacked body, the stacked body is provided with a body portion and an elastic element, the body portion movably combines the head portion and the neck portion, and the elastic element separately abuts against the body portion and the neck portion, to elastically abut against the limiting portion when the head portion enters the limiting portion.

In the stacked body, the stacked body or a body portion of the stacked body is provided with a joining portion, and the joining portion is configured to be joined to the base body.

In the stacked body, the head portion is provided with an inclined portion, and the inclined portion is configured to enter or abut against the limiting portion.

In the stacked body, the stacked body is provided with a body portion, the body portion movably combines the head portion and the neck portion, the neck portion is provided with an external thread portion, and the body portion is provided with an internal thread portion, configured to perform locking after the head portion enters the limiting portion to clip and fix the object.

In the stacked body, the stacked body is provided with a body portion, the body portion movably combines the head portion and the neck portion, the neck portion is provided with an external thread portion, the body portion is provided with an internal thread portion, the head portion enters a channel from the entering portion to the limiting portion, the external thread portion of the neck portion is locked into the internal thread portion of the body portion, the channel is larger than the external thread portion and smaller than a restriction portion of the neck portion, the limiting portion is larger than the restriction portion and smaller than the head portion, and the external thread portion is locked with the internal thread portion to restrict the stacked body to the object through the restriction portion.

In the stacked body, the stacked body is provided with a body portion, the body portion movably combines the head portion and the neck portion, the neck portion is provided with an internal thread portion, the body portion is provided with an external thread portion, the head portion enters a channel from the entering portion to the limiting portion, the internal thread portion of the neck portion is locked into the external thread portion of the body portion, the channel is larger than the external thread portion and smaller than a restriction portion of the neck portion, the limiting portion is larger than the restriction portion and smaller than the head portion, and the external thread portion is locked with the internal thread portion to restrict the stacked body to the object through the restriction portion.

In the stacked body, the stacked body is provided with an abutting portion, the abutting portion is configured to be pressed by the head portion to be deformed to abut against the object, or the abutting portion is an elastic body, a deformable body, a metal body, or a non-metal body.

In the stacked body, the stacked body is provided with an abutting portion, the abutting portion is configured to be pressed by a moving portion to be deformed to abut against the base body, or the abutting portion is an elastic body, a deformable body, a metal body, or a non-metal body.

In the stacked body, a moving portion is further included, the moving portion is movably connected or bolted to the neck portion, or the moving portion is a pulling portion, and the moving portion is pulled to or abuts against the base body or an abutting portion is configured to press the base body, or the moving portion is configured to rotate to 60 degrees, 90 degrees, 130 degrees, 150 degrees, 180 degrees, 210 degrees, between 60 degrees and 130 degrees, or between 150 degrees and 210 degrees.

In the stacked body, the stacked body has a fixed portion, configured to be fastened or fixed by a fastening body or a fixing portion, or the fixed portion is located at a position of the head portion; the head portion passes through an entering portion of the object and enters the limiting portion of the object through the neck portion, or the fastening body or the fixing portion fastens or fixes the fixed portion to fix the object; or a plurality of head portions pass through entering portions of a plurality of objects and enter limiting portions of the plurality of objects through the neck portions, or the fastening body or the fixing portion fastens or fixes the fixed portion to fix the object; or the plurality of head portions pass through an entering portion of the object and enter the limiting portion of the object through the neck portions, or the fastening body or the fixing portion fastens or fixes the fixed portion to fix the object.

In the stacked body, the stacked body has a fixed portion, configured to be fastened or fixed by a fastening body or a fixing portion; or the fixed portion is located at a position of the head portion, configured to be fastened or fixed to the fastening body or the fixing portion, or configured to be fastened or fixed to the fastening body or the fixing portion to fix the object.

In the stacked body, two stacked bodies exist, one stacked body has two head portions, to cause entering portions of two objects to pass through the head portions and enter limiting portions of the two objects through two neck portions for limiting; and the other stacked body has one head portion, and the head portion has a fixed portion, to cause a fastening body or a fixing portion to fasten or fix the object to the fixed portion after the limiting portion that is of the object and that is away from the base body enters the stacked body having two head portions.

In the stacked body, two stacked bodies exist, to cause the entering portion of the object to pass through two head portions and enter two limiting portions of the object through the neck portion for limiting; and the head portions each have a fixed portion, to cause a fastening body or a fixing portion to fasten or fix the object to the fixed portions.

In the stacked body, one or two stacked bodies exist, to cause the entering portion of the object to pass through one or two head portions and enter one or two limiting portions of the object through one or two neck portions for limiting, and a fastening body or a fixing portion performs transverse limiting after the fastening body or the fixing portion disposed on the base body limits a longitudinal position of the object at the one or two head portions.

In the stacked body, the stacked body has a fixed portion located at the head portion, or the fixed portion is an internal thread, an external thread, a concave portion, a convex portion, a hole portion, a slot portion, a fastening body, a cylindrical body, or an elastic fastening body.

In the stacked body, a plurality of stacked bodies are configured to stack a plurality of objects, are configured to longitudinally fix the plurality of objects through a plurality of head portions, and are sequentially configured to cause a fastening body or a fixing portion to fasten or fix the objects for transverse limiting.

The present disclosure provides another method for assembling a stacked body. The method provides at least one stacked body provided with at least one head portion and at least one neck portion, to cause the stacked body to be disposed on a base body, and the head portion passes through an entering portion of at least one object and enters a limiting portion of the object through the neck portion, to cause the stacked body to limit the object. The base body or the object has a carrier or a plurality of carriers, or at least one carrier exists on the base body or the object, or on a top surface or a bottom surface of a plurality of layers of objects, or between objects, or an electric connection exists between carriers, or an electric connection exists between the base body, the object, the plurality of layers of objects, or the carrier, or the base body, the object, the carrier, or the plurality of carriers are a transistor, an IC, a semiconductor, a capacitor, a resistor, a heat sink, an electric wire, a connector, a circuit, a printed circuit board, a memory, a metal body, or a plastic body.

The present disclosure provides another method for assembling a stacked body. The method provides at least one stacked body provided with at least one head portion and at least one neck portion, to cause the stacked body to be disposed on a base body, and the head portion passes through an entering portion of at least one object and enters a limiting portion of the object through the neck portion, to cause the stacked body to limit the object. The base body or the object is provided with a fastening body or a fixing portion, and the fastening body or the fixing portion performs transverse limiting after performing longitudinal limiting on the head portion of the stacked body and the limiting portion of the object.

The present disclosure provides another method for assembling a stacked body. The method provides at least one stacked body provided with at least one head portion and at least one neck portion, to cause the stacked body to be disposed on a base body, and the head portion passes through an entering portion of at least one object and enters a limiting portion of the object through the neck portion, to cause the stacked body to limit the object. The stacked body has a fixed portion, configured to be fastened or fixed by a fastening body or a fixing portion, or the fixed portion is located at a position of the head portion; the head portion passes through an entering portion of the object and enters the limiting portion of the object through the neck portion, or the fastening body or the fixing portion fastens or fixes the fixed portion to fix the object; or a plurality of head portions pass through entering portions of a plurality of objects and enter limiting portions of the plurality of objects through the neck portions, or the fastening body or the fixing portion fastens or fixes the fixed portion to fix the object; or the plurality of head portions pass through an entering portion of the object and enter the limiting portion of the object through the neck portions, or the fastening body or the fixing portion fastens or fixes the fixed portion to fix the object.

The present disclosure provides another method for assembling a stacked body. The method provides at least one stacked body provided with at least one head portion and at least one neck portion, to cause the stacked body to be disposed on a base body, and the head portion passes through an entering portion of at least one object and enters a limiting portion of the object through the neck portion, to cause the stacked body to limit the object. Two stacked bodies exist, one stacked body has two head portions, to cause entering portions of two objects to pass through the head portions and enter limiting portions of the two objects through two neck portions for limiting; and the other stacked body has one head portion, and the head portion has a fixed portion, to cause a fastening body or a fixing portion to fasten or fix the object to the fixed portion after the limiting portion that is of the object and that is away from the base body enters the stacked body having two head portions.

The present disclosure provides another method for assembling a stacked body. The method provides at least one stacked body provided with at least one head portion and at least one neck portion, to cause the stacked body to be disposed on a base body, and the head portion passes through an entering portion of at least one object and enters a limiting portion of the object through the neck portion, to cause the stacked body to limit the object. Two stacked bodies exist, to cause the entering portion of the object to pass through two head portions and enter two limiting portions of the object through the neck portion for limiting; and the head portions each have a fixed portion, to cause a fastening body or a fixing portion to fasten or fix the object to the fixed portions. Alternatively, one or two stacked bodies exist, to cause the entering portion of the object to pass through one or two head portions and enter one or two limiting portions of the object through one or two neck portions for limiting, and a fastening body or a fixing portion performs transverse limiting after the fastening body or the fixing portion disposed on the base body limits a longitudinal position of the object at the one or two head portions.

The present disclosure provides another method for assembling a stacked body. The method provides at least one stacked body provided with at least one head portion and at least one neck portion, to cause the stacked body to be disposed on a base body, and the head portion passes through an entering portion of at least one object and enters a limiting portion of the object through the neck portion, to cause the stacked body to limit the object. A plurality of stacked bodies exist, the plurality of stacked bodies are configured to stack a plurality of objects, are configured to longitudinally fix the plurality of objects through a plurality of head portions, and are sequentially configured to cause a fastening body or a fixing portion to fasten or fix the objects for transverse limiting.

In this way, according to a stacked body of the present disclosure, the stacked body may be disposed on a base body, to cause the stacked body to limit at least one object, to complete combination and separation of at least two objects, thereby achieving an objective of repeated and rapid combination and separation.

### BRIEF DESCRIPTION OF THE DRAWINGS

FIG. 1 is a schematic diagram of an appearance according to a first embodiment of the present disclosure.

FIG. 2 is a schematic diagram of a cross-sectional state according to a first embodiment of the present disclosure.

FIG. 3 is a schematic diagram of another appearance according to a first embodiment of the present disclosure.

FIG. 4 is a schematic diagram of different aspects of a fastening body according to the present disclosure.

FIG. 5 is a schematic diagram of a second embodiment of the present disclosure.

FIG. 6 is a schematic diagram of a third embodiment of the present disclosure.

FIG. 7 is a schematic diagram of a fourth embodiment of the present disclosure.

FIG. 8 is a schematic diagram of a fifth embodiment of the present disclosure.

FIG. 9 is a schematic diagram of a sixth embodiment of the present disclosure.

FIG. 10 is a schematic diagram of a seventh embodiment of the present disclosure.

FIG. 11 is a schematic diagram of an eighth embodiment of the present disclosure.

FIG. 12 is a schematic diagram of a ninth embodiment of the present disclosure.

FIG. 13 is a schematic diagram of a tenth embodiment of the present disclosure.

FIG. 14 is a schematic diagram of an eleventh embodiment of the present disclosure.

FIG. 15 is a schematic diagram of a twelfth embodiment of the present disclosure.

FIG. 16 is a schematic diagram of different aspects of a fixed portion according to the present disclosure.

### DETAILED DESCRIPTION OF THE INVENTION

To fully understand the objectives, features, and effects of the present disclosure, the present disclosure is described in detail by using the following specific embodiments with reference to the accompanying drawings. Descriptions are as follows.

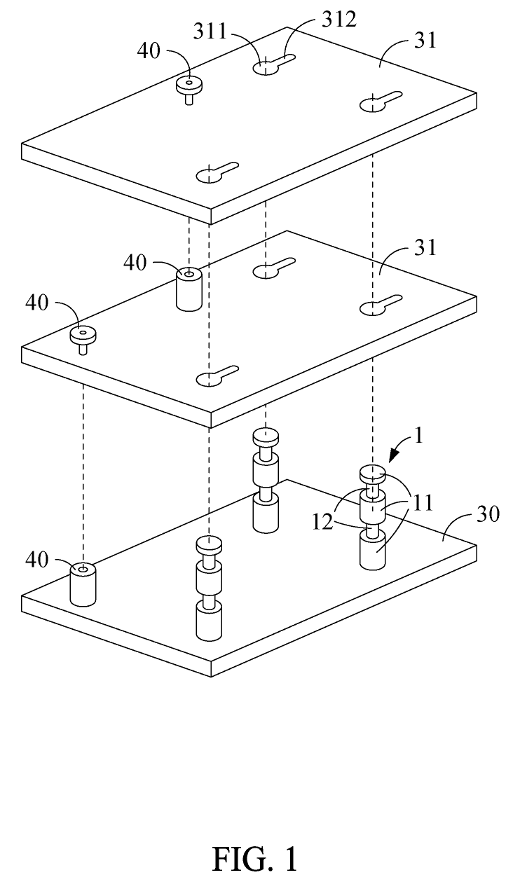

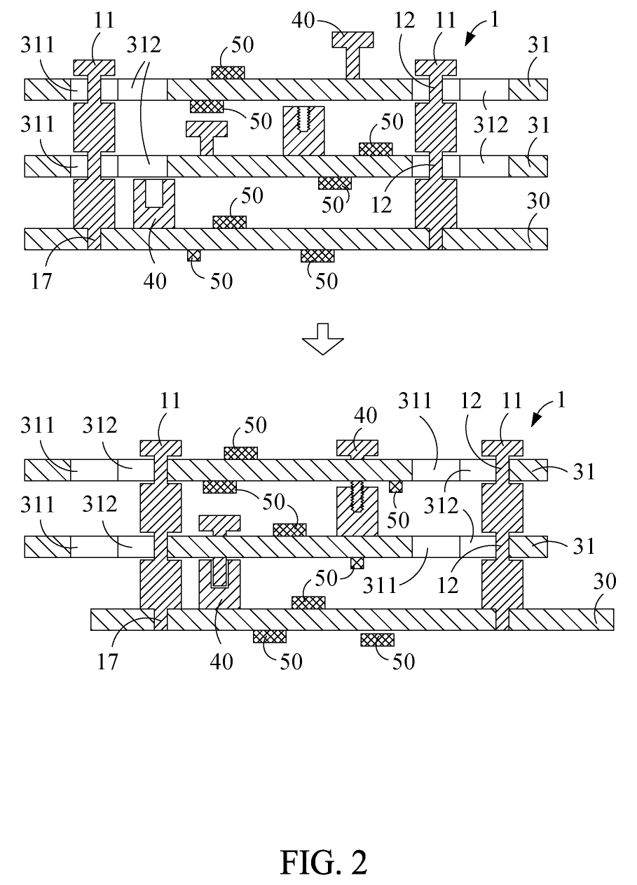

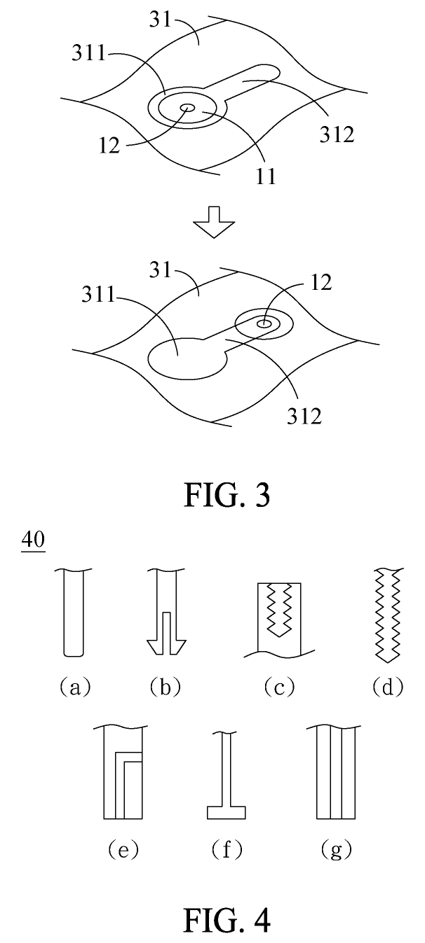

Referring to FIGS. 1 - FIG. 4, as shown in the figures, the present disclosure provides a stacked body, including at least one stacked body 1 provided with at least one head portion 11 and at least one neck portion 12, the stacked body 1 is configured to be disposed on a base body 30, the head portion 11 passes through an entering portion 311 of at least one object 31 and enters a limiting portion 312 of the object 31 through the neck portion 12, to cause the stacked body 1 to limit the object 31. When being removed, the neck portion 12 is moved from the limiting portion 312 to the entering portion 311, to cause the head portion 11 to pass through the entering portion 311 for separation. In this way, at least two objects (for example, the base body 30 and the at least one object 31) may be combined and separated, to achieve an objective of repeated and rapid combination and separation.

In addition to the foregoing embodiment, in a preferred specific embodiment of the present disclosure, the head portion 11 is larger than the limiting portion 312, the entering portion 311 is larger than the head portion 11, and the neck portion 12 is smaller than the limiting portion 312, so that after the head portion 11 passes through the entering portion 311 of the at least one object 31, the neck portion 12 enters the limiting portion 312 of the at least one object 31, to cause the stacked body 1 to limit the object 31 to perform longitudinal limiting. In this way, a stable layer-stacked combination of the stacked body 1 and the objects 31 may be achieved.

In addition to the foregoing embodiment, in a preferred specific embodiment of the present disclosure, a quantity of stacked bodies 1 disposed on the base body 30 may be one, two, three, or more than three, and a quantity of objects 31 may also be one, two, three, or more than three. In this way, an appropriate quantity of stacked bodies 1 may be disposed on the base body 30 according to a required application requirement, so that most of the stacked bodies 1 are disposed on the base body 30, for disposing or limiting most of the objects 31. Therefore, the present disclosure can better satisfy an actual use requirement.

In addition to the foregoing embodiment, in a preferred specific embodiment of the present disclosure, a quantity of head portions 11 and a quantity of neck portions 12 may be one, two, three, or more. In this way, an appropriate quantity of head portions 11 and an appropriate quantity of neck portions 12 that are disposed on the stacked body 1, and a large quantity of objects 31 may be disposed and limited according to a required application requirement. Therefore, the present disclosure can better satisfy an actual application requirement.

In addition to the foregoing embodiment, in a preferred specific embodiment of the present disclosure, the base body 30 or the object 31 is provided with a fastening body 40 (or the fixing portion). The fastening body 40 (or the fixing portion) may be a cylindrical body (for example, a part a in FIG. 4), an elastic fastening body (for example, a part b in FIG. 4), an internal thread body (for example, a part c in FIG. 4), an external thread body (for example, a part d in FIG. 4), an inner fastening body (for example, a part e in FIG. 4), an outer fastening body (for example, a part f in FIG. 4), a hole body (for example, a part g in FIG. 4), or a slot body. The fastening body 40 (or the fixing portion) performs longitudinal limiting on the head portion 11 of the stacked body 1 and the limiting portion 312 of the object 31, or performs transverse limiting after longitudinal limiting. In this way, the fastening body 40 may be used as an auxiliary means, so that the stacked body 1 and the fastening body 40 cooperate with each other, and a stable layer-stacked combination of the stacked body 1, the base body 30, and the objects 31 is achieved.

In addition to the foregoing embodiment, in a preferred specific embodiment of the present disclosure, the base body 30 and the stacked body 1 stack two layers, three layers, or more than three layers of objects 31, and longitudinal limiting of the objects 31 is restricted and transverse limiting of the objects 31 is restricted by using the fastening body 40 (or the fixing portion). In this way, the fastening body 40 may be used as an auxiliary means, so that the stacked body 1 and the fastening body 40 cooperate with each other, and a stable layer-stacked combination of the stacked body 1, the base body 30, and the objects 31 is achieved.

In addition to the foregoing embodiment, in a preferred specific embodiment of the present disclosure, the base body 30 or the object 31 may be a circuit board, a heat sink, a chip, a slide track, a casing, a conductive body, a light guide body, an optical fiber, a tube, a chassis, a metal body, or a non-metal body. In this way, the present disclosure can better satisfy an actual use requirement.

In addition to the foregoing embodiment, in a preferred specific embodiment of the present disclosure, the stacked body 1 or a body portion 13 of the stacked body 1 is provided with a joining portion 17, and the joining portion 17 is configured to be joined to the base body 30. In this way, the stacked body 1 or the body portion 13 and the base body 30 may be stably combined by using the joining portion 17, to facilitate performing an operation when a stable layer-stacked combination of the object 31 is performed.

In addition to the foregoing embodiment, in a preferred specific embodiment of the present disclosure, the base body 30 and the object 31 may have a carrier 50 or a plurality of carriers 50 simultaneously or respectively; or at least one carrier 50 exists on the base body 30 or the object 31, or on a top surface or a bottom surface of a plurality of layers of objects 31, or between objects 31, where an electric connection exists between some carriers 50; or an electric connection exists between the base body 30, the object 31, the plurality of layers of objects 31, or the carrier 50, where the base body 30, the carrier 50, or the plurality of carriers 50 may be an IC, a chip, a connector, a capacitor, a resistor, a heat sink, a fan, a printed circuit board, a conductive body, a light guide body, an optical fiber, a tube, a metal body, a non-metal body, or a plastic body. In this way, the present disclosure can better satisfy an actual use requirement.

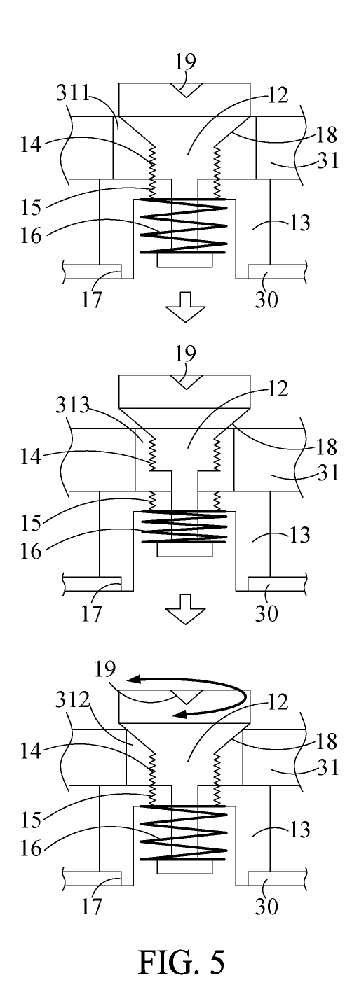

Referring to FIG. 5, as shown in the figure, in addition to the foregoing embodiment, in a preferred specific embodiment of the present disclosure, the stacked body 1 is provided with the body portion 13, the body portion 13 movably combines the head portion 11 and the neck portion 12, the head portion 11 is provided with an external thread portion 14, and the body portion 13 is provided with an internal thread portion 15, configured to perform locking after the head portion 11 enters a channel 313 from the entering portion 311 to the limiting portion 312 to clip and fix the object 31. In this way, a stable layer-stacked combination of the stacked body 1, the base body 30, and the objects 31 may be achieved, to complete combination and separation of at least two objects (for example, the base body 30 and the at least one object 31), thereby achieving an objective of repeated and rapid combination and separation.

In addition to the foregoing embodiment, in a preferred specific embodiment of the present disclosure, an elastic element 16 is further included, the elastic element 16 separately abuts against the body portion 13 and the neck portion 12, to elastically abut against the limiting portion 312 when the head portion 11 enters the limiting portion 312, and then the external thread portion 14 of the head portion 11 is locked into the internal thread portion 15 of the body portion 13 to clip and fix the object 31. In this way, a stable layer-stacked combination of the stacked body 1, the base body 30, and the objects 31 may be achieved.

In addition to the foregoing embodiment, in a preferred specific embodiment of the present disclosure, the head portion is provided with an inclined portion 18 and an operation portion 19, and the inclined portion 18 is configured to enter or abut against the limiting portion 312. In this way, a force may be applied to the operation portion 19, so that when the head portion 11 enters the limiting portion 312, the elastic element 16 elastically abut against the limiting portion 312, the external threaded portion 14 of the head portion 11 is locked into the internal threaded portion 15 of the body portion 13, and the inclined portion 18 is configured to enter or abut against the limiting portion 312, to cause the head portion 11 and the body portion 13 to clip and fix the object 31. In this way, a stable layer-stacked combination of the stacked body 1, the base body 30, and the objects 31 may be achieved.

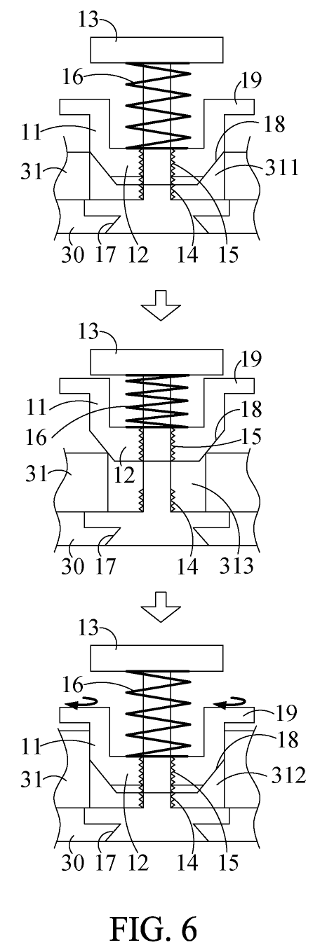

Referring to FIG. 6, as shown in the figure, in addition to the foregoing embodiment, in a preferred specific embodiment of the present disclosure, the stacked body 1 is provided with the body portion 13, the body portion 13 movably combines the head portion 11 and the neck portion 12, the neck portion 12 is provided with the external thread portion 14, and the body portion 13 is provided with the internal thread portion 15, configured to perform locking after the head portion 11 enters the channel 313 from the entering portion 311 to the limiting portion 312 to clip and fix the object 31. In this way, a stable layer-stacked combination of the stacked body 1, the base body 30, and the objects 31 may be achieved.

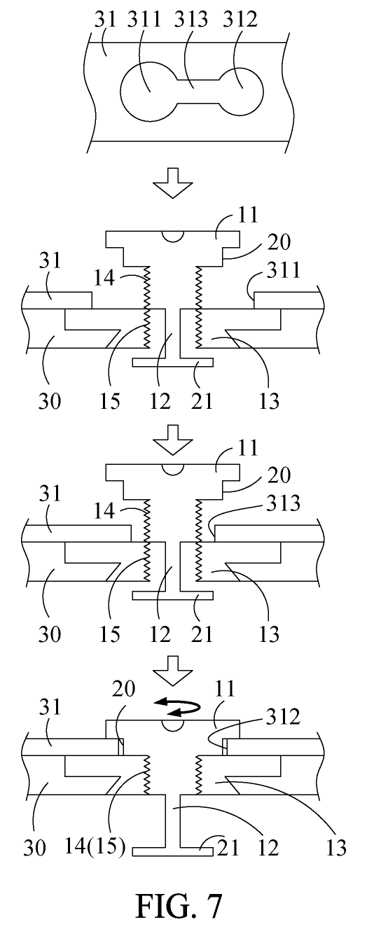

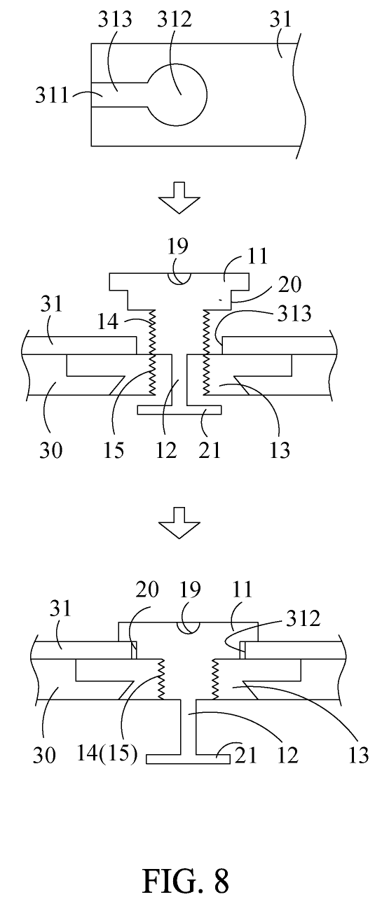

Referring to FIGS. 7 and FIG. 8, as shown in the figures, in addition to the foregoing embodiment, in a preferred specific embodiment of the present disclosure, the stacked body 1 is provided with the body portion 13, the body portion 13 movably combines the head portion 11 and the neck portion 12, the neck portion 12 is provided with the external thread portion 14, the body portion 13 is provided with the internal thread portion 15, the head portion 11 enters the channel 313 from the entering portion 311 to the limiting portion 312, the external thread portion 14 of the neck portion 12 is locked into the internal thread portion 15 of the body portion 13, the channel 313 is larger than the external thread portion 14 and smaller than a restriction portion 20 of the neck portion 12, the limiting portion 312 is larger than the restriction portion 20 and smaller than the head portion 11, and the external thread portion 14 is locked with the internal thread portion 15, to restrict the stacked body 1 to the object 31 through the restriction portion 20. In this way, a stable layer-stacked combination of the stacked body 1, the base body 30, and the objects 31 may be achieved.

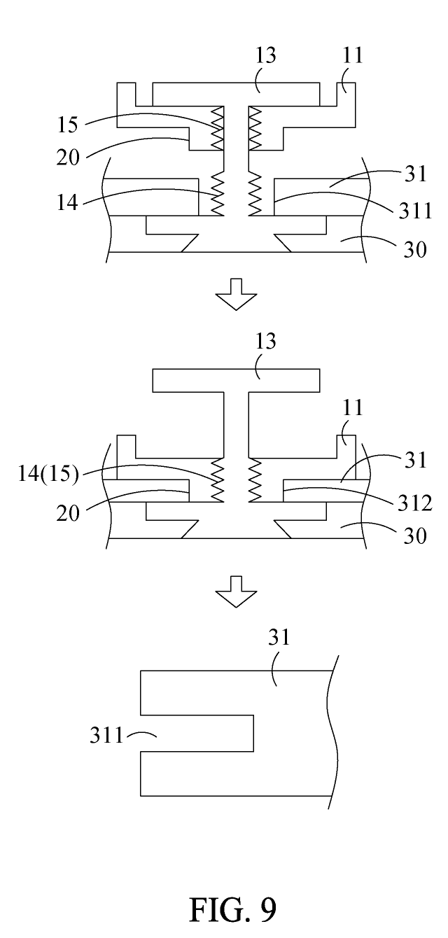

Referring to FIG. 9, as shown in the figure, in addition to the foregoing embodiment, in a preferred specific embodiment of the present disclosure, the stacked body 1 is provided with the body portion 13, the body portion 13 movably combines the head portion 11 and the neck portion 12, the neck portion 12 is provided with the internal thread portion 15, the body portion 11 is provided with the external thread portion 14, the head portion 11 enters the channel 313 from an entering portion 311 to the limiting portion 312, the internal thread portion 15 of the neck portion 12 is locked into the external thread portion 14 of the body portion 13, the channel 313 is larger than the external thread portion 14 and smaller than the restriction portion 20 of the neck portion 12, the limiting portion 312 is larger than the restriction portion 20 and smaller than the head portion 11, and the external thread portion 14 is locked with the internal thread portion 15, to restrict the stacked body 1 to the object 31 through the restriction portion 20. In this way, a stable layer-stacked combination of the stacked body 1, the base body 30, and the objects 31 may be achieved.

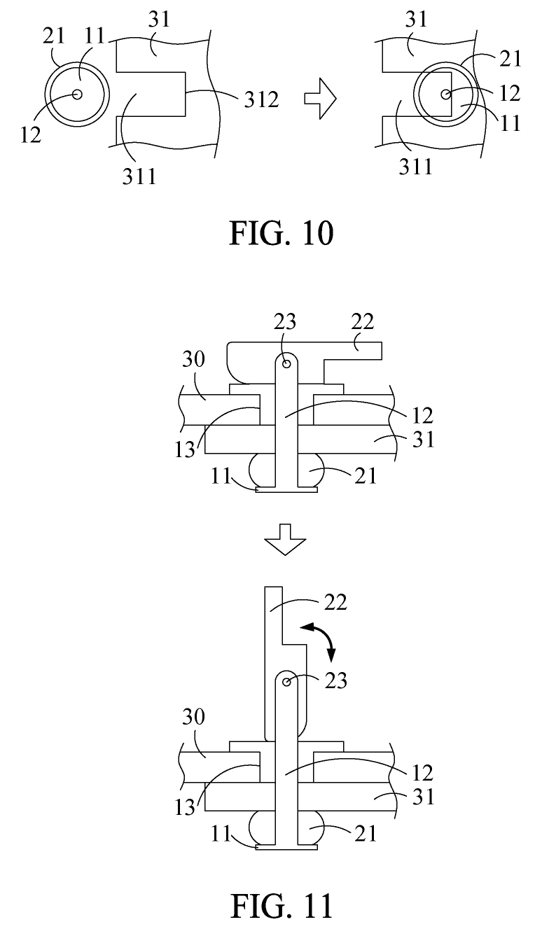

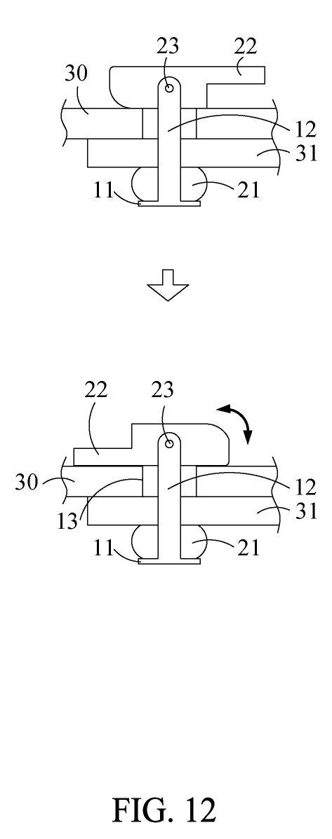

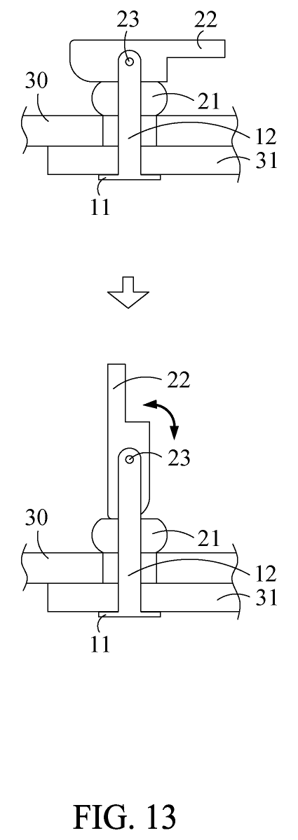

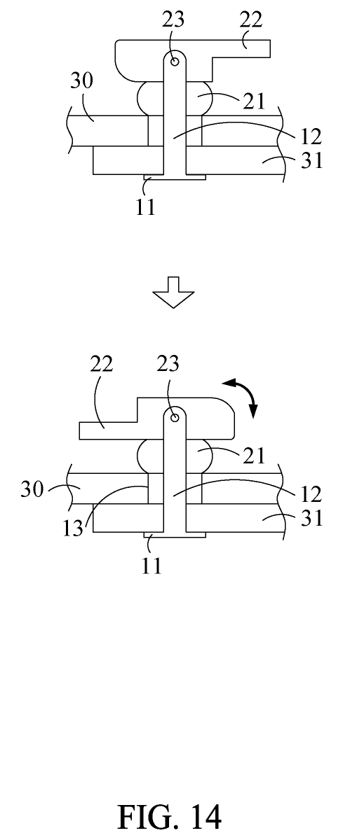

Referring to FIGS. 10-FIG. 14, as shown in the figures, in addition to the foregoing embodiment, in a preferred specific embodiment of the present disclosure, the stacked body 1 is provided with an abutting portion 21, the abutting portion 21 is an elastic body, a deformable body, a metal body, or a non-metal body, and the abutting portion 21 is configured to be pressed by the head portion 11 to be deformed to abut against the base body 30 or the object 31; and a moving portion 22 is further included, the moving portion 22 is movably connected or bolted to the neck portion 12 through a bolted body 23, the moving portion 22 in this embodiment may be a pulling portion, and the moving portion 22 may be configured to rotate to 60 degrees, 90 degrees, 130 degrees, 150 degrees, 180 degrees, 210 degrees, between 60 degrees and 130 degrees, or between 150 degrees and 210 degrees. In this way, the moving portion 22 is pulled to and abuts against the base body 30, or the moving portion 22 is pulled to press the base body 30 through the abutting portion 21, so that the abutting portion 21 is pressed by the moving portion 22 to be deformed to abut against the object 31 (as shown in FIGS. 11 and FIG. 12), or the abutting portion 21 is configured to be pressed by the moving portion to be deformed to abut against the base body 30 (as shown in FIGS. 11 and FIG. 12),

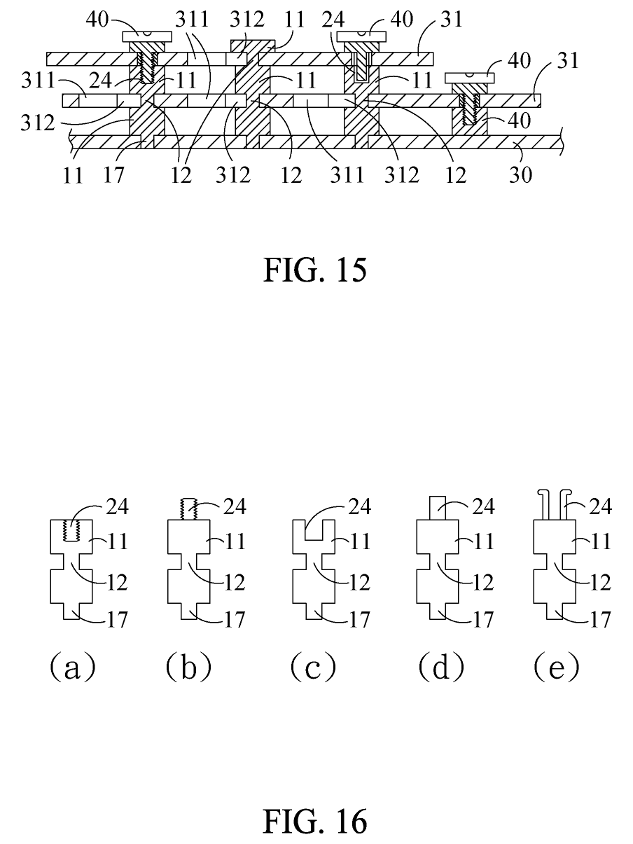

Referring to FIGS. 15 and FIG. 16, as shown in the figures, in addition to the foregoing embodiment, in a preferred specific embodiment of the present disclosure, the stacked body 1 is provided with a fixed portion 24, configured to be fastened or fixed by the fastening body 40 (or the fixing portion), or the fixed portion 24 is located at a position of the head portion 11, configured to be fastened or fixed to the fastening body 40 (or the fixing portion), or configured to be fastened or fixed to the fastening body 40 (or the fixing portion) to fix the object 31.

In addition to the foregoing embodiment, in a preferred specific embodiment of the present disclosure, after the head portion 11 passes through the entering portion 311 of the object 31 and enters the limiting portion 312 of the object 31 through the neck portion 12, the fastening body 40 (or the fixing portion) may fasten or fix the fixed portion 24 to fix the object 31; or after a plurality of head portions 11 pass through entering portions 311 of a plurality of objects 31 and enter limiting portions 312 of the plurality of objects 31 through the neck portions 12, the fastening body 40 (or the fixing portion) may fasten or fix the fixed portion 24 to fix the object 31; or after the plurality of head portions 11 pass through the entering portion 311 of the object 31 and enter the limiting portion 312 of the object 31 through the neck portions 12, the fastening body 40 (or the fixing portion) may fasten or fix the fixed portion 24 to fix the object 31. In this way, a stable layer-stacked combination of the stacked body 1 and the objects 31 may be achieved.

In addition to the foregoing embodiment, in a preferred specific embodiment of the present disclosure, the fixed portion 24 may be an internal thread (for example, a part a in FIG. 16), an external thread (for example, a part b in FIG. 16), a concave portion (for example, a part c in FIG. 16), a convex portion (or a cylindrical body, for example, a part d in FIG. 16), an elastic fastening body (for example, a part e in FIG. 16), a hole portion, a slot portion, or a fastening body. In this way, the fixed portion 24 can better satisfy an actual application requirement.

In addition to the foregoing embodiment, in a preferred specific embodiment of the present disclosure, a plurality of stacked bodies 1 are configured to stack the plurality of objects 31, are configured to longitudinally fix the plurality of objects 31 through the plurality of head portions 11, and are sequentially configured to cause the fastening body 40 (or the fixing portion) to fasten or fix the objects 31 for transverse limiting. In this way, the stacked bodies 1 can better satisfy an actual use requirement.

In addition to the foregoing embodiment, in a preferred specific embodiment of the present disclosure, two stacked bodies 1 exist, one stacked body 1 has two head portions 11, to cause entering portions 311 of two objects 31 to pass through the head portions 11 and enter limiting portions 312 of the two objects 31 through two neck portions 12 for limiting; and the other stacked body 1 has one head portion 11, the head portion 11 has the fixed portion 24, to cause the fastening body 40 (or the fixing portion) to fasten or fix the object 31 to the fixed portion 24 after the limiting portion 312 that is of the object 31 and that is away from the base body 30 enters the stacked body 1 having two head portions 11. In this way, the present disclosure can better satisfy an actual use requirement.

In addition to the foregoing embodiment, in a preferred specific embodiment of the present disclosure, two stacked bodies 1 exist, to cause the entering portion 311 of the object 31 to pass through two head portions 11 and enter two limiting portions 312 of the object 31 through the neck portion 12 for limiting; and the head portions 11 each have a fixed portion 24, to cause the fastening body 40 (or the fixing portion) to fasten or fix the object 31 to the fixed portion 24. In this way, the present disclosure can better satisfy an actual use requirement.

In addition to the foregoing embodiment, in a preferred specific embodiment of the present disclosure, one or two stacked bodies 1 exist, to cause the entering portion 311 of the object 31 to pass through one or two head portions 11 and enter one or two limiting portions 312 of the object 31 through one or two neck portions 12 for limiting, and the fastening body 40 (or the fixing portion) performs transverse limiting after the fastening body 40 (or the fixing portion) disposed on the base body 30 limits a longitudinal position of the object 31 at the one or two head portions 11 (as shown in FIG. 15).

The present disclosure is disclosed through the foregoing preferred embodiments. However, a person skilled in the art should understand that the embodiments are merely used for describing the present disclosure, and should not be construed as limiting the scope of the present disclosure. It should be noted that, any equivalent change or replacement with the embodiments should be covered in the scope of the present disclosure. Therefore, the protection scope of the present disclosure shall be subject to the protection scope of the present disclosure.

What is claimed is:

1. A stacked body, comprising at least one stacked body provided with at least one head portion and at least one neck portion, wherein the stacked body is configured to be disposed on a base body, and the head portion passes through an entering portion of at least one object and enters a limiting portion of the object through the neck portion, to cause the stacked body to limit the object.

2. The stacked body according to claim 1, wherein a quantity of stacked bodies disposed on the base body is one, two, three, or more than three, or a quantity of head portions is one, two, three, or more than three, or a quantity of neck portions is one, two, three, or more than three; or a quantity of objects is one, two, three, or more than three; or the base body is provided with a plurality of stacked bodies and a plurality of objects for limiting.

3. The stacked body according to claim 1, wherein the base body or the object is provided with a fastening body or a fixing portion, and the fastening body or the fixing portion performs transverse limiting after performing longitudinal limiting on the head portion of the stacked body and the limiting portion of the object; or the fastening body or the fixing portion is a cylindrical body, an elastic fastening body, an internal thread body, an external thread body, an inner fastening body, an outer fastening body, a hole body, or a slot body.

4. The stacked body according to claim 1, wherein the head portion is larger than the limiting portion, the entering portion is larger than the head portion, and the neck portion is smaller than the limiting portion.

5. The stacked body according to claim 1, wherein the base body or the object is a circuit board, a heat sink, a chip, a slide track, a casing, a conductive body, a light guide body, an optical fiber, a tube, a chassis, a metal body, or a non-metal body, or the base body or the object has a carrier or a plurality of carriers, or the carrier or the plurality of carriers are an IC, a chip, a connector, a capacitor, a resistor, a heat sink, a fan, a printed circuit board, a conductive body, a light guide body, an optical fiber, a tube, a metal body, a non-metal body, or a plastic body.

6. The stacked body according to claim 1, wherein the base body or the object has a carrier or a plurality of carriers, or at least one carrier exists on the base body or the object, or on a top surface or a bottom surface of a plurality of layers of objects, or between objects, or an electric connection exists between carriers, or an electric connection exists between the base body, the object, the plurality of layers of objects, or the carrier, or the base body, the object, the carrier, or the plurality of carriers are a transistor, an IC, a semiconductor, a capacitor, a resistor, a heat sink, an electric wire, a connector, a circuit, a printed circuit board, a memory, a metal body, or a plastic body.

7. The stacked body according to claim 1, wherein the base body and the stacked body stack two layers, three layers, or more than three layers of objects, and restrict longitudinal limiting of the objects; or the base body and the stacked body stacks two layers, three layers, or more than three layers of objects, restrict longitudinal limiting of the objects, and restrict transverse limiting of the objects by using a fastening body or a fixing portion.

8. The stacked body according to claim 1, wherein the stacked body is provided with a body portion, the body portion movably combines the head portion and the neck portion, the head portion is provided with an external thread portion, and the body portion is provided with an internal thread portion, configured to perform locking after the head portion enters the limiting portion to clip and fix the object; or the stacked body further comprises an elastic element, the elastic element separately abuts against the body portion and the neck portion, to elastically abut against the limiting portion when the head portion enters the limiting portion, or to elastically abut against the limiting portion when the head portion enters the limiting portion, and to lock the external thread portion of the head portion into the internal thread portion of the body portion to clip and fix the object.

9. The stacked body according to claim 1, wherein the stacked body is provided with a body portion and an elastic element, the body portion movably combines the head portion and the neck portion, and the elastic element separately abuts against the body portion and the neck portion, to elastically abut against the limiting portion when the head portion enters the limiting portion; or the stacked body is provided with a body portion, the body portion movably combines the head portion and the neck portion, the neck portion is provided with an external thread portion, and the body portion is provided with an internal thread portion, configured to perform locking after the head portion enters the limiting portion to clip and fix the object.

10. The stacked body according to claim 1, wherein the stacked body or a body portion of the stacked body is provided with a joining portion, and the joining portion is configured to be joined to the base body; or the head portion is provided with an inclined portion, and the inclined portion is configured to enter or abut against the limiting portion.

11. The stacked body according to claim 1, wherein the stacked body is provided with a body portion, the body portion movably combines the head portion and the neck portion, the neck portion is provided with an external thread portion, the body portion is provided with an internal thread portion, the head portion enters a channel from the entering portion to the limiting portion, the external thread portion of the neck portion is locked into the internal thread portion of the body portion, the channel is larger than the external thread portion and smaller than a restriction portion of the neck portion, the limiting portion is larger than the restriction portion and smaller than the head portion, and the external thread portion is locked with the internal thread portion to restrict the stacked body to the object through the restriction portion.

12. The stacked body according to claim 1, wherein the stacked body is provided with a body portion, the body portion movably combines the head portion and the neck portion, the neck portion is provided with an internal thread portion, the body portion is provided with an external thread portion, the head portion enters a channel from the entering portion to the limiting portion, the internal thread portion of the neck portion is locked into the external thread portion of the body portion, the channel is larger than the external thread portion and smaller than a restriction portion of the neck portion, the limiting portion is larger than the restriction portion and smaller than the head portion, and the external thread portion is locked with the internal thread portion to restrict the stacked body to the object through the restriction portion.

13. The stacked body according to claim 1, wherein the stacked body is provided with an abutting portion, the abutting portion is configured to be pressed by the head portion to be deformed to abut against the object, or the abutting portion is an elastic body, a deformable body, a metal body, or a non-metal body; or the abutting portion is configured to be pressed by a moving portion to be deformed to abut against the base body, or the abutting portion is an elastic body, a deformable body, a metal body, or a non-metal body.

14. The stacked body according to claim 1, further comprising a moving portion, wherein the moving portion is movably connected or bolted to the neck portion, or the moving portion is a pulling portion, the moving portion is pulled to or abuts against the base body, or an abutting portion is configured to press the base body, or the moving portion is configured to rotate to 60 degrees, 90 degrees, 130 degrees, 150 degrees, 180 degrees, 210 degrees, between 60 degrees and 130 degrees, or between 150 degrees and 210 degrees.

15. The stacked body according to claim 1, wherein the stacked body has a fixed portion, configured to be fastened or fixed by a fastening body or a fixing portion, or the fixed portion is located at a position of the head portion; the head portion passes through an entering portion of the object and enters the limiting portion of the object through the neck portion, or the fastening body or the fixing portion fastens or fixes the fixed portion to fix the object; or a plurality of head portions pass through entering portions of a plurality of objects and enter limiting portions of the plurality of objects through the neck portions, or the fastening body or the fixing portion fastens or fixes the fixed portion to fix the object; or the plurality of head portions pass through an entering portion of the object and enter the limiting portion of the object through the neck portions, or the fastening body or the fixing portion fastens or fixes the fixed portion to fix the object.

16. The stacked body according to claim 1, wherein the stacked body has a fixed portion, configured to be fastened or fixed by a fastening body or a fixing portion, or the fixed portion is located at a position of the head portion, configured to be fastened or fixed to the fastening body or the fixing portion, or configured to be fastened or fixed to the fastening body or the fixing portion to fix the object.

17. The stacked body according to claim 1, wherein two stacked bodies exist, one stacked body has two head portions, to cause entering portions of two objects to pass through the head portions and enter limiting portions of the two objects through two neck portions for limiting, or the other stacked body has one head portion, and the head portion has a fixed portion, to cause a fastening body or a fixing portion to fasten or fix the object to the fixed portion after the limiting portion that is of the object and that is away from the base body enters the stacked body having two head portions.

18. The stacked body according to claim 1, wherein two stacked bodies exist, to cause the entering portion of the object to pass through two head portions and enter two limiting portions of the object through the neck portion for limiting; or the head portions each have a fixed portion, to cause a fastening body or a fixing portion to fasten or fix the object to the fixed portions.

19. The stacked body according to claim 1, wherein one or two stacked bodies exist, to cause the entering portion of the object to pass through one or two head portions and enter one or two limiting portions of the object through one or two neck portions for limiting, and a fastening body or a fixing portion performs transverse limiting after the fastening body or the fixing portion disposed on the base body limits a longitudinal position of the object at the one or two head portions.

20. The stacked body according to claim 1, wherein the stacked body has a fixed portion located at the head portion, or the fixed portion is an internal thread, an external thread, a concave portion, a convex portion, a hole portion, a slot portion, a fastening body, a cylindrical body, or an elastic fastening body.

21. The stacked body according to claim 1, wherein a plurality of stacked bodies are configured to stack a plurality of objects, are configured to longitudinally fix the plurality of objects through a plurality of head portions, and are sequentially configured to cause a fastening body or a fixing portion to fasten or fix the objects for transverse limiting.
